(19) United States
(12) Patent Application Publication
(10) Pub. No.: US 2009/0057521 A1
(43) Pub. Date: Mar. 5, 2009

(54) Tie-down bracket

(76) Inventor: Collen V. Bootsman, Alberta (CA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/896,286

(22) Filed: Aug. 30, 2007

(51) Int. Cl. F16M 13/00

(52) U.S. Cl. 248/530

(57) ABSTRACT

The bracket comprises an upright tube and a cleat connected to one side of the tube. The cleat has a pair of horizontal, transversely extending horns protruding from the tube. In use, a pair of the brackets are pivotally mounted on the upper ends of the shafts of embedded screw piles bracketing a pipeline. A flexible tie-down strap, having loop ends, extends across the pipeline. The loop ends each releasably engage one of the brackets. Each loop end extends over the bracket tube and is trapped beneath the cleat, so as to bear against the side surface of the tube lower end. The loop end and bracket can readily be engaged or disengaged in the field.

### FIELD OF THE INVENTION

The present invention relates to a bracket for use as a connector between a flexible tie-down strap and an anchor screw pile, applied, for example, in the context of a pipeline tie-down assembly.

### BACKGROUND OF THE INVENTION

Despite being buried beneath the ground, pipelines, such as those used to convey oil or gas, sometimes undergo longitudinal and/or upward movement. Such movement can arise from elongation or contraction due to temperature changes, both inside and outside the pipeline. It also can arise due to buoyancy effects when traversing water-saturated soil, such as muskeg.

It is common practice to tie down or restrain upward movement of the pipeline, to counteract the movement. This is usually accomplished using what is referred to as a pipeline tie-down assembly or system.

There are two main categories of pipeline tie-down systems. One uses weights to hold the pipeline down. The other uses anchors, usually screw piles, embedded in the ground and bracketing the pipeline, with the anchors connected by a restraining cross-piece extending over and across the pipeline.

The present invention relates to an anchor-type system which can be used to restrain buried pipelines, gas station storage tanks and the like.

One particular example of an anchor-type pipeline tie-down assembly is disclosed in Canadian patent 2,191,145, issued to Johannesson et al. This assembly comprises:
a pair of embedded screw piles for bracketing the pipeline;
a flexible tie-down strap having loop ends;
a pair of brackets, each mounted on the upper end of a screw pile, the bracket comprising a tube, which slides over the pile end and which can rotate or pivot theron, and a coaxial sleeve which is connected to the tube at one side thereof;
whereby one of each of the strap loop ends threads through one of the sleeves to connect the strap at its ends with the brackets;
first means are provided on the upper end of each screw pile, for limiting the downward travel of the bracket at a pre-determined elevation; and
second means are provided on each pile for disengagably locking the bracket against upward movement when it is seated on the first means.

There are problems associated with a bracket such as that disclosed in the aforementioned prior art.

More specifically:
The ends of the strap are doubled back and sewn to the central portion of the strap, to create the loops. Sewing is normally carried out at a facility ‘in town’. As a consequence, the strap ends are threaded through the sleeves and sewn at this facility. The strap and brackets are therefore necessarily conveyed to ‘the field’ as a unitary assembly;
As a result, if the strap needs to be replaced, it can't be easily separated in the field from the brackets. Furthermore, one end of the strap, attached to its heavy steel bracket, usually needs to be passed across the exposed pipeline in the course of the assembly. There is a risk that the bracket may be inadvertently dropped on the pipeline and may damage the impermeable plastic coating on the steel pipe of the pipeline. This is highly undesirable from the point of view of the pipeline contractor;
In addition, it is sometimes desirable to introduce a second pipeline beside the first and this may require replacing the strap with a longer one. And finally the pipeline owner will usually maintain an inventory of tie-down parts. It is desirable in that connection to have separate components.

For these reasons there is a need for a modified bracket that can easily be engaged and disengaged with the strap in the field.

### SUMMARY OF THE INVENTION

In accordance with the invention a bracket is provided which can easily be connected or disconnected in the field with the loop end of a flexible tie-down strap.

The bracket comprises:
a tube for sliding over the upper end of an embedded screw pile, whereby the tube is pivotally mounted on the pile; and
a cleat, connected to the tube and positioned at one side thereof, said cleat having a pair of horns protruding horizontally and transversely from the tube when the latter is upright, as it would be when positioned on the screw pile.

The bracket may incorporate one or more of the following preferred features:
each horn comprises a thicker inner root portion and a thinner outer terminal portion;
the terminal portion of each horn is angled or bent inwardly toward the tube;
the cleat is positioned intermediate the ends of the tube; and
the horns are configured to conform with the engaged strap loop end so that the side portions of the loop can seat and bear against the thick root portion of the cleat.

In a tie-down assembly embodiment of the invention, a pair of the brackets are pivotally mounted on the upper ends of a pair of embedded screw piles bracketing a member to be restrained, such as a pipeline. A flexible tie-down strap having loop ends extends across the member. The loop ends releasably engage the brackets. Removable stop means limit the upward travel of the brackets along the screw piles, at pre-determined elevations.

This embodiment may incorporate one or more of the following preferred features:
the strap loop ends are each formed with a folded twist; and
each loop end extends over the tube and is trapped beneath the cleat of its associated bracket and bears against the surface of the bottom end of the tube, to thereby engage the cleat and lock against the tube.

### DESCRIPTION OF THE DRAWINGS

FIG. 1 is a top view of a bracket in accordance with the invention;

FIG. 2 is a front side view of the bracket;

FIG. 3 is a side view of the bracket;

FIG. 4 is similar to FIG. 1, with the addition of showing a strap loop end, having a folded twist configuration, engaging the cleat of the bracket;

FIG. 5 is similar to FIG. 2 with the addition of showing the strap loop end releasably engaging the bracket;

FIG. 6 is similar to FIG. 3 with the addition of showing the strap loop end engaging the bracket with the end portion of the loop trapped beneath the cleat and bearing against the surface of the bottom end of the tube;

FIG. 7 is a side end view showing a pipeline in a ditch with embedded screw piles bracketing the pipeline, the pipeline being restrained with a tie-down assembly;

FIG. 8 is a side view showing the upper end of a screw pile with a bracket mounted thereon and engaging a strap loop end and a lock nut limiting upward movement of the bracket; and

FIG. 9 is a front side view of the bracket mounted on the upper end of the screw pile and locked in place by a lock nut.

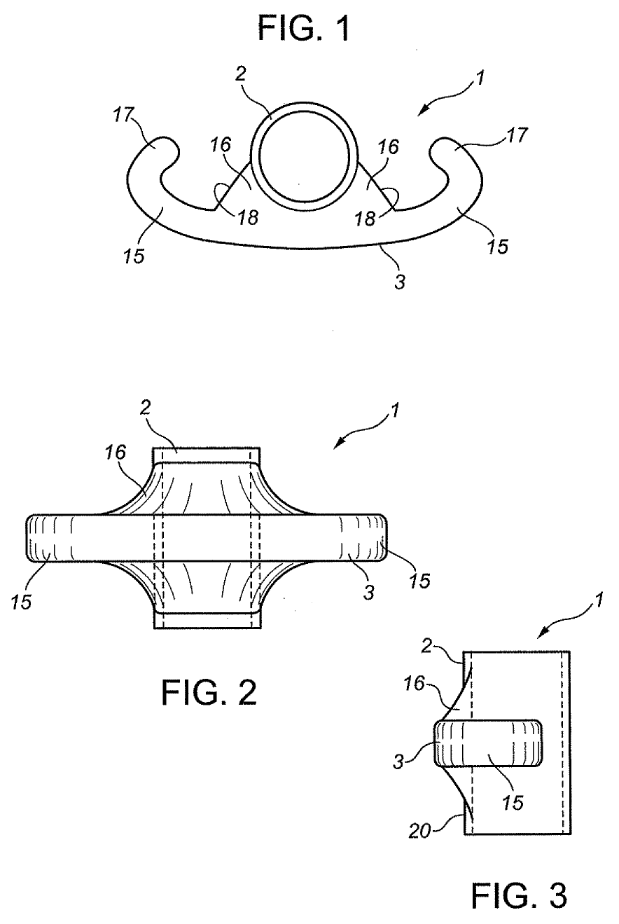

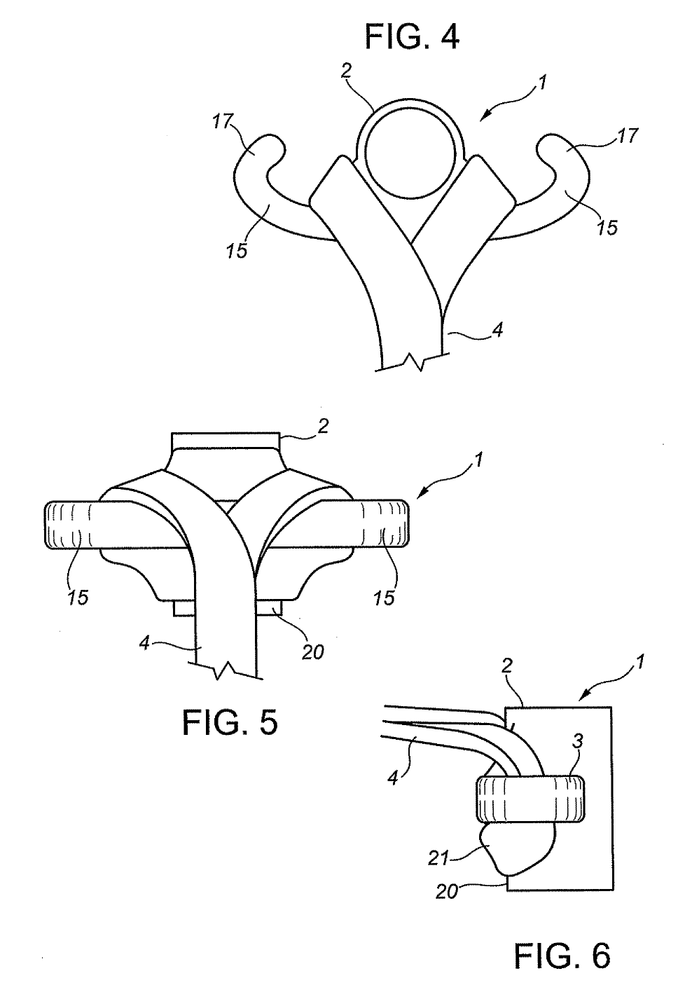

### DESCRIPTION OF A PREFERRED EMBODIMENT

Having reference to the Figures, a bracket 1, for use in the context of a pipeline tie-down assembly 7, is shown. The bracket 1 comprises a tube 2 having a cleat 3 connected thereto. The bracket 1 functions as a connector between a loop end 4 of a flexible tie-down strap 5 and an embedded screw pile 6.

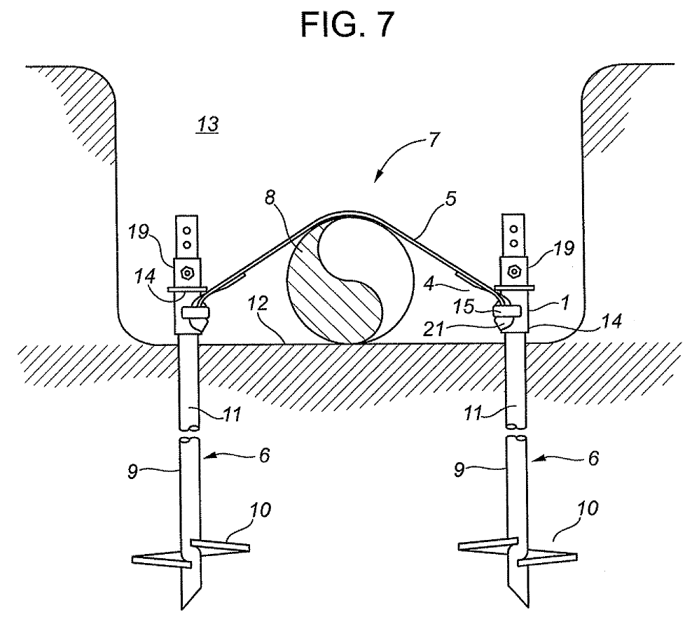

As shown in FIG. 7, the pipeline tie-down assembly 7 comprises a pair of embedded screw piles 6 bracketing a pipeline 8 and joined by the tie-down strap 5. The screw piles 6 function as anchors and the tie-down strap 5 functions to restrain the pipeline 8 against upward movement.

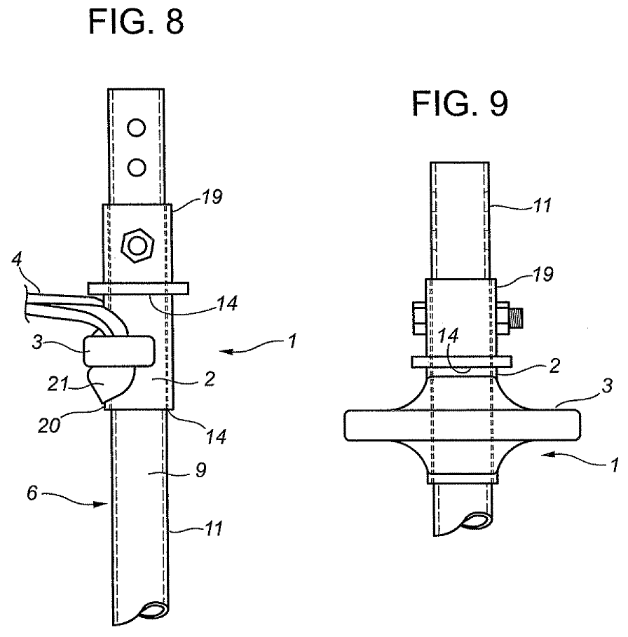

In greater detail, each screw pile 6 comprises a shaft 9 having one or more helices 10 attached to its lower end. The shaft 9 is usually comprised of connectable sections so that the length of the shaft may be varied to allow the helices 10 to be embedded in a solid ground formation. The upper end 11 of the shaft 9 protrudes above the bottom surface 12 of a ditch 13 at the time of constructing the tie-down assembly 7. As shown in FIG. 8, a removable tubular stop 19 overlies the shaft 9 and may be disengagably locked in place by nut and bolt 19a. The stop 19 carries a shoulder 14 at its lower end, for limiting the upward movement of the bracket 1 at a pre-determined elevation.

The bracket tube 2 is sized to slide over and fit the shaft's upper end 11. It is free to rotate or pivot thereon.

The cleat 3 is connected to the tube 2 and is positioned at one side thereof. It comprises a pair of horns 15 which protrude generally horizontally and transversely from the tube 2, when the latter is positioned over the screw pile 6.

Each horn 15 is somewhat arcuately shaped. It comprises an inner root portion 16 and an outer terminal portion 17. As shown, the root portion 16 is thicker than the terminal portion 17. The terminal portion 17 is angled or bent inwardly toward the tube 2. Each root portion 16 provides a surface 18 against which the loop end 4 may bear when the loop end 4 and cleat 3 are engaged. The thicker root portion 16 is intended to resist the pull of the strap 5. The thinner terminal portions 17 function to contain the loop end 4 and resist having it slip off the cleat 3.

The cleat 3 is connected to the tube 2 at a point intermediate its ends. As a result, the lower end of the tube 2 forms an underlying surface 20 against which the central portion 21 of the loop end 4 may bear when the strap 5 engages the bracket 1.

The strap loop ends 4 are each formed with what is known as a folded twist 22.

In assembly, each loop end 4 is extended over its associated bracket tube 2 and is then doubled back so that its central portion 21 seats against the tube underlying surface 20 and is trapped beneath the cleat 3. The side members 22 of the loop end 4 seat against the seating surfaces 18 of the horn root portions 16 as the loop end 4 is drawn tight.

From the foregoing it will be appreciated that the loop ends 4 of the strap 4 can be readily engaged or disengaged in the field with brackets 1 mounted on the piles 6.

The cleat horns 15 are shown in this preferred embodiment as generally arcuate so that, even though short and compact in length, they still function to retain the engaged loop ends 4 in place. However it is contemplated that they could be straight, although longer, or could be provided with protruberances or other means to assist in retaining the loop end in place. While a stop shoulder 14 has been shown as the means for limiting upward travel of the bracket 1 on the shaft upper end 11, other means, such as threaded engagement between the shaft 9 and bracket 1, could also be used. Other variants for the various components of the assembly will be apparent to one of ordinary skill in the art.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A bracket, for use as a connector between the loop end of a flexible tie-down strap and the upper end of an upright embedded screw pile forming part of a tie-down assembly, comprising:
a tube to be pivotally mounted on the upper end of the screw pile; and
a cleat, connected to the tube and positioned at one side thereof, said cleat having a pair of horns which protrude horizontally and transversely from the tube when the latter is positioned on the screw pile.

2. The bracket as set forth in claim 1 wherein each horn comprises an inner root portion and an outer terminal portion, the root portion being thicker than the terminal portion, the terminal portions being angled inwardly toward the tube.

3. The bracket as set forth in claim 1 wherein the cleat is positioned intermediate the ends of the tube, whereby the strap loop end may be extended over the tube and trapped beneath the cleat against the surface of the bottom end of the tube to thereby engage the cleat and lock against the tube.

4. The bracket as set forth in claim 1, wherein the tube and cleat are integral.

5. A tie-down assembly for restraining a pipeline comprising:
a pair of embedded screw piles for bracketing the pipeline;
a pair of brackets for sliding over and pivotally engaging the upper ends of the screw piles, each bracket comprising a tube, sized to fit on the screw pile, and a cleat, connected to the tube and positioned at one side thereof, said cleat having a pair of horns which protrude horizontally and transversely from the tube when the latter is positioned on a screw pile;
stop means for limiting upward travel of a bracket along its associated screw pile upper end; and
a flexible strap having loop ends for releasably engaging the brackets.

6. The tie-down assembly as set forth in claim 5 wherein:
each horn comprises an inner root portion and an outer terminal portion, the root portion being thicker than the terminal portion.

7. The tie-down assembly as set forth in claim 5 wherein:
each cleat is positioned intermediate the ends of its associated tube.

8. The tie-down assembly as set forth in claim 7 wherein:
the terminal portions of the horns of each bracket are angled inwardly.

9. The tie-down assembly as set forth in claim 7 wherein the strap loop ends are each formed with a folded twist and the horns of each bracket are shaped to conform with a loop end when the latter is extended over the tube of the bracket and is trapped beneath the cleat and bears against the underlying surface of the bottom end of the tube to thereby engage the bracket.

10. A tie-down assembly for restraining a pipeline, comprising:
a pair of embedded screw piles bracketing the pipeline;
a pair of brackets, each mounted on and pivotally engaging the upper end of a screw pile, each bracket comprising a tube and a cleat connected to the tube and positioned at one side thereof the cleat having a pair of horns which protrude horizontally and transversely from the tube;
removable stop means, mounted on the upper end of each screw pipe, for limiting upward travel of the bracket along its associated screw pipe upper end at a pre-determined elevation; and
a flexible strap extending over the pipeline and having loop ends engaging the brackets, each loop end extending over the tube of the bracket which it is engaging so that it is trapped beneath the cleat and bears against the surface bottom end of the tube.

11. The assembly as set forth in claim 10 wherein:
each horn comprises an inner root portion and an outer terminal portion, the root portion being thicker than the terminal portion;
each loop is formed with a folded twist; and
each cleat is positioned intermediate the ends of its associated tube.
